(19) United States
(12) Patent Application Publication
(10) Pub. No.: US 2007/0207255 A1
(43) Pub. Date: Sep. 6, 2007

(54) PLANT-DERIVED PROTEIN COMPOSITIONS

(75) Inventor: Donald L. Crank, Alexandria, MN (US)

Correspondence Address: MICHAEL BEST & FRIEDRICH, LLP, ONE SOUTH PINCKNEY STREET, P O BOX 1806, MADISON, WI, 53701, US

(73) Assignee: SPECIALTY PROTEIN PRODUCERS, INC., Port Washington, WI (US)

(21) Appl. No.: 11/681,397

(22) Filed: Mar. 2, 2007

Related U.S. Application Data
(60) Provisional application No. 60/779,108, filed on Mar. 3, 2006.

(51) Int. Cl. A23L 1/20

(52) U.S. Cl. 426/634; 426/646

(57) ABSTRACT

Disclosed are plant protein compositions prepared from a non-hexane, non-alcohol treated plant material having a Protein Dispersibility Index of at least 65%. Also disclosed are plant protein compositions prepared from a high pressure liquid extracted plant material having a Protein Dispersibility Index of at least 65%. The plant protein compositions comprise at least 65% dry weight protein or a protein to fat ratio of at least 6 to 1.

### CROSS-REFERENCE TO RELATED APPLICATIONS

This application claims the benefit of U.S. Provisional Patent Application No. 60/779,108 filed Mar. 3, 2006, which is incorporated by reference herein.

### STATEMENT REGARDING FEDERALLY SPONSORED RESEARCH

None.

### INTRODUCTION

Plant materials, such as soybeans, are processed to produce a wide variety of food products. Recently, consumer demand for low- or reduced-fat, high-protein plant-derived products has increased dramatically. In addition, consumer demand is growing for natural, organic and environmentally friendly or “green” food products. Several methods are currently used commercially to process plant materials, such as soybeans, into a protein-enriched, reduced-fat composition for use in food production, including solvent extraction and a variety of press-based methods, e.g., extruder, expeller, continuous and cold presses, to separate at least a portion of the fat from the remaining plant material.

Both solvent extraction and press-based methods produce an oil fraction and a defatted or reduced-fat flake or cake containing the protein-enriched fraction. In solvent extraction a solvent, commonly hexane, is used to produce an oil and flake that contains residual solvent. These solvents are not natural and cannot be used to produce certified organic food products under United States Department of Agriculture (USDA) guidelines for organic food labeling.

In contrast, the press-based methods can be used to produce foods that may be certified organic. The oil recovery rate from many of the press-based methods is incomplete and a fairly high percentage of fat remains in the cake. The hot press methods also require high temperatures to function and result in increased protein denaturation, poor solubility and loss of protein functionality.

A relatively new method was developed using carbon dioxide under high pressure in a screw-type press. This high-pressure liquid extraction method (HPLE) produces a reduced-fat cake with intact protein. The cake resulting from HPLE, like that from other screw press processes, can be certified organic.

### SUMMARY

In one aspect, a plant protein composition comprising at least about 65% dry weight protein is provided. The plant protein composition is prepared from a high pressure liquid extracted plant material having a Protein Dispersibility Index (PDI) of at least about 65%. Food products comprising these plant protein compositions are also provided.

In another aspect, a plant protein composition comprising at least about 65% dry weight protein is provided. The plant protein composition is prepared from a non-hexane, non-alcohol treated plant material having a PDI of at least about 65%. Food products comprising these plant protein compositions are also provided.

In yet another aspect, a plant protein composition comprising a protein to fat ratio of at least 6 to 1 is provided. The plant protein composition is prepared from a non-hexane, non-alcohol treated plant material having a PDI of at least 65%. Food products comprising these plant protein compositions are also provided.

### DETAILED DESCRIPTION OF THE INVENTION

The present invention provides plant protein compositions and food products made using the plant protein compositions. The plant protein compositions provided can be made using organic plants to make products that are organic certifiable under USDA requirements for food labeling. The plant protein compositions disclosed are reduced-fat compositions containing at least 65% dry weight protein or having a protein to fat ratio of at least 6 to 1 (w/w).

The plant protein compositions are made using high-pressure liquid extraction (HPLE). HPLE is a recently developed screw press method of defatting plant materials. HPLE uses a gas, such as carbon dioxide, under high-pressure conditions to assist in the removal of fat from plant materials. By “high pressure” it is meant conditions under which at least a portion of the gas exists as a liquid. Typical gases used include, but are not limited to, carbon dioxide, nitrogen and propane. The functionality of the resulting partially defatted cake is improved as compared to traditional hot press defatted plant products. The Examples demonstrate HPLE defatted soybean material produces a soybean protein composition superior to hot press defatted soybean material. A soy isolate (i.e. a soy protein composition comprising at least 90% dry weight protein) was obtained from the HPLE defatted soybean material, but not from the hot press defatted soybean material. In addition, flour made from HPLE defatted soybean material had a higher Protein Dispersibility Index than did flour made from hot press defatted soybean material.

The plant protein compositions can be made from any plant material, including but not limited to, soybean, canola (rapeseed), castor bean, cottonseed, flaxseed, palm kernel, linseed, candlenut, sesame seed, peanut, coconut, corn, corn germ, sunflower, safflower, oats, chia, kukui, pumpkin, walnut, grape, primrose, rice bran, almond, olive, avocado, beech, brazil, pecan, pistachio, hickory, filbert, macadamia, cashew, neem, hemp, lupin, coffee, poppy, red pepper, mustard seed, wheat and wheat germ. The plants can be prepared for processing using any suitable means known in the art including, but not limited to, drying, conditioning to achieve an equilibrated moisture level, dehulling, cracking, and cleaning to remove trash, weeds, hulls or other undesirable material from the plant materials by counter current air aspiration, screening methods or other methods known in the art.

The plant materials are subjected to HPLE and the resulting partially defatted cakes are optionally further processed by milling into flour by any suitable means including, but not limited to, using a hammer mill, roller mill or a screw-type mill. The resulting flour can have a variety of particle sizes. Suitably 40 to 100 mesh flour is used for extraction, more suitably 100 to 600 mesh flour is used for extraction, but any suitable flour, flake, grit, meal or cake may be used.

The HPLE partially defatted plant material is extracted with an aqueous solution. The term “aqueous solution” as used herein includes water substantially free of solutes (e.g., tap water, deionized water or distilled water) and water comprising solutes. As one of skill in the art will appreciate, the aqueous solution may contain additives such as salts, buffers, acids and bases. The extraction temperatures may be between 32° F. and 200° F., suitably from about 32° F. to about 150° F., more suitably between about 80° F. and about 150° F., more suitably between about 90° F. and about 145° F. and even more suitably between about 110° F. and 140° F. Products having different functional characteristics may be obtained by including additives or varying the extraction temperature.

In the Examples below, tap water was added to the flour in a ratio of about 16 parts by weight to each part of partially defatted flour or cake, but smaller or larger amounts of aqueous solution may be added. In the Examples, the pH was adjusted by adding a base, such as calcium hydroxide, sodium hydroxide, ammonium hydroxide or potassium hydroxide, to facilitate extraction of the proteins. Suitably the pH is adjusted to between 6.0 and 10.5, even more suitably the pH is adjusted to between about 7.0 and about 9.0. The extraction may be conducted with or without agitation for a period of time effective to extract the protein. Suitably the extraction is conducted for at least 10 minutes, and more suitably the extraction is conducted for at least 30 minutes 1 hour, 2 hours or 4 hours. As one of skill in the art will appreciate, longer extraction periods may be used.

The extract may be separated from insoluble by-product (e.g., insoluble fiber or okara) by centrifugation. This may be accomplished using horizontal decanters, disk-type desludgers, disk-type clarifiers, or similar machines to separate liquids and solids. In the Examples, a disk-type clarifying centrifuge was utilized to remove the insoluble by-product. Optionally, to increase recovery of protein, the insoluble by-product can be washed. Aqueous solution is added to the insoluble by-product and centrifuged as described above to extract additional material from the defatted plant material. A disk-type clarifying centrifuge may optionally be used to remove residual insoluble by-product from the extracts. Optionally additional fat can be removed from the extract using the centrifugal fat separation methods of U.S. Provisional Patent Application Ser. No. 60/778,802, U.S. Ser. No. 11/681,215, filed Mar. 2, 2007, entitled “Methods of Separating Fat from Soy Materials and Compositions Produced Therefrom”, or U.S. Ser. No. 11/681,217, filed Mar. 2, 2007, entitled “Methods of Separating Fat from Non-Soy Plant Materials and Compositions Produced Therefrom”, each of which is incorporated by reference in its entirety.

The resulting extract is then further processed to make plant protein compositions by concentration and separation methods known in the art, such as acid precipitation of the proteins and filtration, e.g., microfiltration, ultrafiltration or diafiltration. These methods can be used to produce plant protein compositions that are organic certifiable. The protein compositions produced may be a concentrate, containing at least 65% protein on a dry weight basis, or suitably an isolate, containing at least 90% protein on a dry weight basis. The final protein products comprise a protein to fat ratio of at least about 5 to 1 (w/w) and optionally a protein to fat ratio of at least about 7 to 1 (w/w) or suitably at least about 9 to 1 (w/w). The plant protein compositions may contain about 15% or less dry weight fat and suitably contain about 10% or less dry weight fat.

In Examples 1 and 2, proteins in the extract were concentrated by precipitation and separated to produce a soy protein composition from partially defatted soybean flour or cake. Briefly, extracted proteins can be precipitated by adding an acid, such as citric acid, to the isoelectric point of the protein. Any suitable acid may be used. The precipitated protein (first curd) can be separated from the first whey in a continuous horizontal decanter, disk-type clarifier, or disk-type desludger, such as the disk-type clarifying centrifuge model SB-7 available from Westfalia Separator Industries (Oelde, Germany) used in the Examples below. The separated first curd constitutes the first plant protein composition. The first plant protein compositions produced in the Examples were washed by adding aqueous solution to the first plant protein composition and centrifuging to produce the second plant protein compositions with higher concentrations of protein. As demonstrated in Examples 1 and 2, a soy isolate containing at least 90% protein was obtained from the HPLE defatted soybean material, but not from the extruder press defatted soybean material. Alternatively, the extract can be concentrated and separated by other methods known in the art, such as filtration.

The products described herein have increased functionality as compared to those organic plant protein products currently available (e.g., those produced by extruder press defatting) at least partly due to the use of starting plant materials having a high Protein Dispersibility Index (PDI). In addition, the resulting products will not contain the undesirable contaminants associated with hexane extracted materials and can be made such that the products are organic certifiable.

These products also have some desirable functional properties associated with plant protein concentrates and isolates. The following functional properties have been or may be evaluated for the plant protein compositions described herein as compared to currently available plant protein compositions: surface hydrophobicity, water binding ability, fat binding, emulsification, gel hardness and deformability, solution particle size, solubility, dispersibility, whippability, viscosity, color and taste as well as others.

Protein:water gel strength is a measure of the strength of a refrigerated gel made using a soy protein composition. The strength of the gel is measured with a TX-TI texture analyzer which drives a cylindrical probe into the gel until the gel is ruptured by the probe and calculating the gel strength from the recorded break point of the gel. As reported in Example 7, all of the products produced from the HPLE plant material have higher gel strength than either comparable hexane defatted or extruder press defatted plant protein compositions. The gel strength of the composition is at least about 20% higher than a comparable soy protein composition that was defatted by hexane extraction or by a hot press method as demonstrated in Example 7. Suitably the gel strength is at least about 10% higher than a comparable soy protein composition that was defatted by hexane extraction or by a hot press method. Increased gel strengths indicate that the soy protein compositions may be useful as high gel food ingredients for many kinds of food products such as meat emulsions, meat analogs, yogurt, imitation cheese, and other products where the ability to form a protein gel in water is desired.

Protein:oil:water emulsion strength is a measure of the strength of a refrigerated oil and water emulsion with soy protein. The strength of the emulsion may be measured with a TX-TI texture analyzer which drives a cylindrical probe into the emulsion until the emulsion is ruptured by the probe and calculating the emulsion strength from the recorded break point of the emulsion. As reported in Example 8, the emulsion strength of the protein compositions produced from HPLE soy materials had significantly greater emulsion strength as compared to other comparable commercially available soy protein compositions. The emulsion strength of the soy protein compositions were at least about 20% higher than a comparable soy protein composition that was defatted by hexane extraction or by a hot press method as measured in Example 8. Suitably the emulsion strength is at least about 10% higher than a comparable soy protein composition that was defatted by hexane extraction or by a hot press method. The firmness of the emulsions was sufficient to provide the requisite structure to a meat emulsion and to be used as protein emulsifiers in other kinds of food systems such as, meat analogs, yogurt, imitation cheeses and the like.

The plant protein compositions described herein have a substantially bland taste and an off-white color such that their use in production of a food product will not alter the taste or color of the food in a way that makes the food product unpalatable. Because the HPLE process can be performed on plant material that has not been hexane or alcohol extracted or exposed to high temperatures, the resulting plant protein compositions may also contain enhanced levels of beneficial microconstituents and decreased levels of constituents that resulting in poor flavor and color.

For example, plant sterols are plant compounds with similar chemical structure and biological functions as cholesterol. Due to their structural similarity to cholesterol, plant sterols were first and foremost studied for their cholesterol absorption inhibition properties. In addition to their cholesterol lowering effect, plant sterols may possess anti-cancer, anti-atherosclerosis, anti-inflammation, and anti-oxidation activities. The action of plant sterols as anticancer dietary components has been recently extensively reviewed (Journal of Nutrition 2000; 130:2127-2130), and plant sterol intake was found to be inversely associated with breast, stomach, and esophageal cancers. In 1999, the FDA allowed food products containing a minimum of 6.25 grams of soy protein per serving to be labeled as reducing cholesterol and improving heart disease. The composition of sterols in plant products, particularly soy proteins, is one of the effective components found in these products for cholesterol reduction. The protein compositions described herein are expected to have increased sterol levels, particularly as compared to hexane extracted protein compositions.

Plant protein compositions may be used to make a wide variety of food products. These food products include, but are not limited to, confectionary products, bakery products, injection meat products, emulsified meat products, ground meat products, meat analog products, cereals, cereal bars, dairy analog products, beverages, liquid or powdered dietetic formula, texturized soy products, pasta, health nutrition supplements, and nutrition bars. In particular, the confectionary products may include, but are not limited to, candy or chocolate. A bakery product may include, but is not limited to, breads, rolls, biscuits, cakes, yeast baked goods, cookies, pastries, or snack cakes. An injection meat product includes, but is not limited to, ham, poultry product, turkey product, chicken product, pork product, seafood product or beef product. An emulsified meat product includes, but is not limited to, sausage, bratwurst, salami, bologna, lunchmeat, or hot dogs. A ground meat product includes, but is not limited to, fish sticks, meat patties, meatballs, ground pork products, ground seafood products, ground poultry products or ground beef products. A meat analog product includes, but is not limited to, sausage, patties, ground meatless crumbles, lunchmeat or hot dogs. A dairy analog product includes, but is not limited to, milk products, yogurt products, sour cream products, whipped topping, ice cream, cheese, shakes, coffee whitener or cream products. A dietetic formula includes, but is not limited to, infant formula, geriatric formula, weight loss preparations, weight gain preparations, sports drinks, or diabetes management preparations. For example, a number of ready to drink beverages may be produced using the protein compositions described herein as a partial or complete protein source. Persons skilled in the art may modify the type and content of proteins, sugar sources, fats and oils, vitamin/mineral blends, flavors, gums, and/or flavors to produce a beverage product designed to meet specific nutritional requirements, product marketing claims, or targeted demographic groups.

The following examples are meant only to be illustrative and are not intended to limit the claims of the invention.

### EXAMPLE 1

### Preparation of Soy Protein Compositions from Extruder Pressed Soy Flour.

Partially defatted soy flour was obtained from Natural Products, Inc. (lot number 062705, Grinnell, Iowa). Dehulled soybean pieces were partially defatted using a mechanical extruder press (Instapro™ Dry Extruder and Continuous Horizontal Press, Des Moines, Iowa) to press the oil out of the pieces, with the partially defatted soy cake discharged from the press being ground with a hammer mill into a 100 mesh, partially defatted soy flour. The partially defatted soy flour had proximate analysis of 6.76% moisture, 53.0% dry basis Kjeldahl protein, 10.2% dry basis acid hydrolyzed fat and a PDI of 55%.

In this and all subsequent examples, the dry basis protein and fat ratios were measured by standard methods. The protein content of the soy materials was determined using the Kjeldahl method (AOAC 18th Ed. Method 991.2.2, Total Nitrogen in Milk, 1994, which is incorporated herein by reference in its entirety). Briefly, samples were digested using acid, catalyst and heat. The digested sample was made alkaline by addition of sodium hydroxide. Steam was then used to distill the sample, releasing ammonia. The ammonia was collected in a receiving vessel and was back titrated with a standardized acid solution. The nitrogen content was then calculated. The protein content is the nitrogen content multiplied by a protein factor. The protein factor used for soy materials is 6.25.

The fat content of the soy materials was determined gravimetrically. Briefly, the sample was weighed into a Mojonnier flask. Acid was added and the sample was heated until the solids were broken down. The sample was cooled and then extracted using alcohol, ethyl ether and pet ether. The flask was centrifuged and the resulting ether/fat layer poured off into a pre-weighed aluminum dish. Samples were subjected to a series of 2 or 3 extractions depending on the fat level. The ether was evaporated and the sample was placed in an oven to dry. The sample was cooled in a desiccator and then weighed as described in the Official Method of Analysis AOAC 922.06, Fat in Flour which is incorporated herein by reference in its entirety.

In addition, the total solids present in the soy material were determined gravimetrically using standard procedures. Briefly, the sample was weighed and placed in an oven at a specific temperature for a specific time. Time and temperature are dependant on the sample type. For powder samples, a vacuum oven set at 100° C. for 5 hours was used. The sample was removed from the oven and cooled in a desiccator. The cooled sample was weighed and the total solids/moisture is calculated as describe in official methods of analysis, Association of Official Analytical Chemists (AOAC), 18th Edition 927.05, Moisture in Dried Milk which is incorporated herein by reference in its entirety.

The Protein Dispersibility Indices of the soy materials were measured using the standard methods of the AOCS, 5th Edition, Method Ba 10-65 which is incorporated herein by reference in its entirety. Briefly, the sample was placed in suspension and blended at 8500 rpm for 10 minutes. A portion of sample slurry was centrifuged and an aliquot of the supernatant was analyzed for Kjeldahl protein. The supernatant protein value was divided by the sample protein value and multiplied by 100 to give the percent PDI.

Fifty pounds of the partially defatted soy flour was extracted with 800 pounds of water at 120° F. in a 100 gallon agitated tank. The pH of the mixture was adjusted to 10.1 by adding one pound of calcium hydroxide (CODEX HL, Mississippi Lime Company, Saint Genevieve, Mo.) and held for a mean time of 2 hours. The extract was separated from the insoluble by-product (okara) using a high g-force, horizontal bowl, decanting centrifuge (Sharples model P-660, Warminster, Pa.) at an extract flow rate of 2-4 pounds per minute with continuous solids discharge. The insoluble by-product (15.7 pounds) was collected and contained 11.3% solids and 40.9% Kjeldahl dry basis protein. The extract had a protein to fat ratio of 4.8 to 1 and contained 54.0% Kjeldahl dry basis protein and 11.3% dry basis acid hydrolyzed fat.

The extract was precipitated by adding citric acid powder (anhydrous FCC grade, Xena International, Inc., Polo, Ill.) to a pH of 4.5 in an agitated tank at 130° F. The mixture was held for 20 minutes with mild agitation, and then fed continuously to a high g-force disk-type clarifying centrifuge (model SB-7, Westfalia Separator Industry GmbH, Oelde, Germany) at a first whey flow rate of 5.4 to 6.6 pounds per minute with intermittent solids discharge of 2.5 second duration on a 5 to 9 minute cycle. The precipitated protein (first curd) was separated from the sugars and other dissolved compounds (first whey). The first curd weighed 19.6 pounds and was recovered as a soy protein concentrate with 75.9% dry basis Kjeldahl protein and 16.3% dry basis acid hydrolyzed fat. The protein to fat ratio was 4.7 to 1.

The first curd was washed by diluting with fresh hot water to a temperature of 135° F. to 7.24% solids, and centrifuging (Sharples model P-660, Warminster, Pa.) at a second whey flow rate of 2.1 to 4.3 pounds per minute with continuous solids discharge to separate protein (second curd) and sugars (second whey). The second curd weighed 18.2 pounds and was recovered as a soy protein concentrate with 82.4% dry basis Kjeldahl protein and 16.7% dry basis acid hydrolyzed fat. The protein to fat ratio was 4.9 to 1.

The second curd was modified by adjusting the solids level to 8.67% with fresh water at 70° F. and the pH to 6.9 with a 10% solution of sodium hydroxide (50% solution, Fisher Scientific, Barnstead International, Dubuque, Iowa). The product was pasteurized in a continuous process with a two-stage plate and frame heat exchanger (model 25HV, Microthermics, Inc, Raleigh, N.C.) at a rate of 3.5 pounds per minute. The neutralized second curd was heated in the first heat exchanger to 195° F., then homogenized (model NS2006H, NIRO Soavi, Hudson, Wis.) in a two stage process with 2500 psi and 500 psi homogenization pressure, respectively. The homogenized second curd was heated in the second stage of the heater to a temperature of 290° F., held for 6 seconds, and cooled to less than 1110° F. before spray drying.

The modified soy protein concentrate was immediately fed to the spray drier (model 1, NIRO Atomizer, Hudson, Wis.) at a feed rate of 40 pounds per hour using a high revolution wheel atomizer. Spray drier inlet air temperature was maintained at 200° C. with outlet air temperature of 93° C. to attain product moisture of 3.55% in the soy isolate powder.

### EXAMPLE 2

### Preparation of Soy Protein Compositions from HPLE Soy Cake.

Partially defatted HPLE soy cake was obtained from SafeSoy Technologies (lot number SS, Ellsworth, Iowa). Dehulled soybean pieces were partially defatted using High Pressure Liquid Extraction (prototype model, Crown Iron Works, Minneapolis, Minn.) to press the oil out of the pieces, with the partially defatted soy cake discharged from the high pressure liquid extractor. The partially defatted soy cake had proximate analysis of 9.6% moisture, 51.8% dry basis Kjeldahl protein, 6.9% dry basis acid hydrolyzed fat and a PDI of 68%.

Fifty pounds of the partially defatted soy cake was ground to 60 mesh powder in a pin mill, and the flour was extracted with 800 pounds of water at 125° F. in a 100 gallon agitated tank. The pH of the mixture was adjusted to 9.02 by addition of 0.5 pound of calcium hydroxide and held for a mean time of 1.5 hours. The extract was separated from the insoluble by-product (okara) using a high g-force, disk-type clarifying centrifuge (model SB-7, Westfalia Separator Industry GmbH, Oelde, Germany) at an extract flow rate of 5.5 to 6.6 pounds per minute with intermittent solids discharge of 2.5 second duration on a 12 minute cycle. The insoluble by-product (17.4 pounds) was collected at 13.5% solids and 42.7% Kjeldahl dry basis protein. The extract had a protein to fat ratio of 9.8 to 1. The extract contained 57.5% Kjeldahl dry basis protein and 5.9% dry basis acid hydrolyzed fat.

The extract was precipitated by adding citric acid powder to a pH of 4.51 in an agitated tank at 130 to 134° F. The precipitated protein was held for 15 minutes with mild agitation, and then fed continuously to a high g-force disk-type clarifying centrifuge (model SB-7, Westfalia Separator Industry GmbH, Oelde, Germany) at a first whey flow rate of 5.5 to 6.6 pounds per minute with intermittent solids discharge of 2.5 second duration on a 10 to 12 minute cycle. The precipitated protein (first curd) was separated from the sugars and other dissolved compounds (first whey). The first curd weighed 17.2 pounds and the resulting product was a soy protein concentrate with 81.6% dry basis Kjeldahl protein and 10.4% dry basis acid hydrolyzed fat. The protein to fat ratio was 7.8 to 1.

The first curd was washed as in Example 1 and the second curd was recovered (15.4 pounds) as a soy protein isolate with 90.5% dry basis Kjeldahl protein and 11.1% dry basis acid hydrolyzed fat. The protein to fat ratio was 8.2 to 1. The second curd was modified by adjusting the solids level to 12.09% with fresh water at 90° F., and adjusting the pH to 7.0 with a 10% solution of sodium hydroxide. The product was pasteurized, homogenized, and spray dried as described in Example 1. A comparison of the soy proteins prepared in Examples 1 and 2 are shown in Table 1.

TABLE 1
PRODUCT COMPOSITION COMPARISONS

| | | EXAMPLE 1 | |
|---|---|---|---|
| | | EXTRUDER | |
| | | PRESS | EXAMPLE 2 |
| NUTRIENTS | UNITS | SOY FLOUR | HPLE SOY FLOUR |
| PROTEIN, DRY BASIS | % | 82.40% | 90.50% |
| FAT | % | 16.10% | 10.70% |
| MOISTURE | % | 3.55% | 3.16% |

Protein levels are 10% higher in the soy protein products produced from the HPLE flour when compared to the extruder press flour primarily due to a 33% reduction in fat content.

### EXAMPLE 3

### Preparation of Functional Soy Protein Concentrate from HPLE Soy Flour by Acid Wash Process.

Thirty-two pounds of HPLE soy flour prepared according to the procedure of Example 2 with a composition of 8.6% moisture, 53.1% dry basis protein, 8.4% dry basis acid hydrolyzed fat and a PDI of 68% was combined with 320 pounds of water at 135° F. in a 50 gallon agitated tank. The pH of the mixture was adjusted by adding 1.3 pounds of citric acid powder to a pH of 4.51 in an agitated tank. The precipitated protein was held for 15 minutes with mild agitation, and then fed continuously to a high g-force decanter centrifuge (Sharples model P-660, Warminster, Pa.) at a feed rate of 5.3 pounds per minute. The precipitated protein and insoluble fiber was separated from the sugars and other dissolved compounds. The first acid washed curd weighed 26.2 pounds and the resulting product was a soy protein concentrate with 62% dry basis Kjeldahl protein and 8.7% dry basis acid hydrolyzed fat. The protein to fat ratio was 7.1 to 1. The soy protein concentrate solids were modified by adjusting the solids level to approximately 12% with fresh water at 90° F. and the pH to 7.3 with a 10% solution of sodium hydroxide. The product was homogenized, pasteurized, and spray dried as identified in Example 1.

### Preparation of Soy Protein Concentrate from Hple Soy Flour by Three-Stage Acid Wash process.

HPLE soy flour (70 grams) prepared according to the procedure of Example 2 with composition of 8.6% moisture, 53.1% dry basis protein, 8.4% dry basis acid hydrolyzed fat and a PDI of 68% was combined with 800 grams of water at 140° F. in a 2 liter agitated beaker. The pH of the mixture was adjusted by adding 50% citric acid solution to a pH of 4.6. The precipitated protein was held for 15 minutes with mild agitation, and then centrifuge in a high g-force International Equipment Company Model K lab centrifuge at 4000 rpm for 10 minutes to separate the protein-fiber fraction from the first whey. The recovered protein-fiber fraction had 66.7% dry basis Kjeldahl protein. One hundred and fifty grams of the first protein-fiber composition was then diluted with 450 grams of fresh hot water to a temperature of 140° F. The mixture was held for ten minutes with mild agitation, and then centrifuged as described above to separate the second protein-fiber composition from the second whey. One hundred and five grams of the second protein-fiber composition was then diluted with 315 grams of fresh hot water to a temperature of 140° F. The mixture was held for ten minutes with mild agitation, and then centrifuged to separate the third protein-fiber composition from the third whey. The recovered protein-fiber composition contained 68.4% dry basis Kjeldahl protein and 9.1% acid hydrolyzed fat for a 7.5 to 1 protein to fat ratio.

### EXAMPLE 4

### Preparation of Soy Protein Composition from HPLE Soy Flour by the Ultrafiltration Process.

HPLE soy flour was obtained from SafeSoy Technologies, Ellsworth, Iowa, and was processed as identified in Example 3. The HPLE soy flour had proximate analysis of 9.6% moisture, 51.8% dry basis Kjeldahl protein, 6.9% dry basis acid fat, and a PDI of 68% for a protein to fat ratio of 7.5 to 1.

Twenty-five pounds of full fat soy flour was extracted with 320 pounds of water at 125° F. in a 100 gallon agitated tank. The pH was adjusted to 6.9 by adding 18 grams of calcium hydroxide and held for a mean time of 60 minutes. The soy extract was separated from the insoluble by-product using a high g-force, disk-type clarifying centrifuge as described in Example 1.

A portion of the soy extract was heated to 102° F. and was further processed by passing it through a microporous ultrafiltration membrane system (model system 1515, PTI Advanced Filtration, San Diego, Calif.) installed with two spiral wound polysulfone membranes with molecular weight cutoff of 10,000 (43 mil spacer, 5.7 square meters filtration area, PTI Advanced Filtration, San Diego, Calif.). One hundred seventy four pounds of soy extract was transferred to a feed tank at 102° F. and 3.44% solids, and 140 pounds of deionized water was added to the soy extract. A feed pump recirculated the extract at 38 gallons per minute with a differential pressure drop across the membrane filter of 17 pounds per square inch. The retentate off the membranes was returned to the feed tank, and the first permeate was discharged until 235 pounds of first permeate was removed, or 74.8% of the weight of the diluted soy extract. The process was completed in 87.5 minutes. Three point two pounds of the first retentate solids were recovered at a 65.2% Kjeldahl dry basis protein, constituting a soy concentrate with 7.2% dry basis acid hydrolyzed fat for a protein to fat ratio of 9.1 to 1.

The first retentate was diluted by adding 235 pounds of deionized water at 102° F., and a second ultrafiltration was carried out using the same conditions as the first separation. The diluted first retentate was recirculated to the membranes until 298 pounds of second permeate was removed in 118 minutes, or 94.9% of the diluted first retentate. Sixteen pounds of second retentate were recovered with 78.0% Kjeldahl dry basis protein content and 8.9% dry basis acid hydrolyzed fat yielding a protein to fat ratio of 8.7 to 1.

The second retentate was modified by adjusting the solids level to about 7% with fresh water at 90° F., and adjusting the pH to 6.9 with a 10% solution of sodium hydroxide. The product was pasteurized, homogenized and spray-dried as described in Example 1.

### EXAMPLE 5 (PROPHETIC)

### Comparison of Reduced Fat Soymilk Products from Soy Proteins Produced from Extruder Pressed and HPLE Prepared Soy Flour.

Commercial soymilk products are prepared from a liquid extract of whole soybeans or alternatively rehydrated soy protein compositions that are wet blended with other ingredients. The minimum quantity of soy proteins utilized in the production of commercial soymilk is equal to the amount of protein necessary to consume a minimum of 6.25 grams of soy protein in a single serving of 240 ml of the commercial soymilk. Using soy proteins produced in Examples 1 and 2 above with the minimum 6.25 grams of soy protein per serving, commercial soymilk products may be prepared according to the formulas in Table 2.

TABLE 2
COMMERCIAL SOYMILK PRODUCT FORMULAS

| | EXAMPLE 1 | |
|---|---|---|
| | PROTEIN | EXAMPLE 2 |
| | FROM EXTRUDER | PROTEIN FROM |
| INGREDIENTS | PRESS SOY FLOUR | HPLE SOY FLOUR |
| WATER | 88.36% | 88.89% |
| SOY PROTEIN | 3.33% | 2.80% |
| SUGARS | 5.00% | 5.00% |
| GUMS | 2.00% | 2.00% |
| VITAMIN/MINERAL | 1.30% | 1.30% |
| FORTIFICATION | | |
| FLAVORINGS | 0.01% | 0.01% |

The commercial soymilk products produced from these formulas are calculated to have the following product compositions identified in Table 3.

TABLE 3
COMMERCIAL SOYMILK PRODUCT COMPOSITIONS

| | EXAMPLE 1 | |
|---|---|---|
| | EXTRUDER | EXAMPLE 2 |
| | PRESS SOY | HPLE |
| | FLOUR | SOY FLOUR |
| PROTEIN, AS IS | 2.53% | 2.53% |
| FAT, AS IS | 0.56% | 0.31% |
| CARBOHYDRATE, AS IS | 7.00% | 7.00% |
| NUTRIENTS PER 240 ML SERVING | | |
| CALORIES | 106.6 | 101.4 |
| % OF CALORIES FROM FAT | 11.7% | 6.8% |
| | GRAMS | GRAMS |
| TOTAL FAT | 1.4 | 0.8 |
| SATURATED FAT | 0 | 0 |
| CHOLESTEROL | 0 | 0 |
| TOTAL CARBOHYDRATE | 17.3 | 17.3 |
| DIETARY FIBER | 0 | 0 |
| SUGARS | 12.4 | 12.4 |
| PROTEIN | 6.3 | 6.3 |

The soymilk produced from soy proteins derived from HPLE soy flour has 44% less fat than the soymilk produced from soy proteins derived from extruder press soy flour. Both soymilk products are low-fat soymilk products. Commercial soymilks that are certified organic may be produced when the starting HPLE or extruder press soy flour is prepared from organic soybeans, and the remaining ingredients are also certified organic.

### EXAMPLE 6

### Preparation of Glycinin-Rich Protein Fraction and a Beta-Conglycinin-Rich Protein Fraction from HPLE Partially Defatted Soybean Flour.

A glycinin-rich protein fraction was prepared using standard methods. Briefly, 2500 grams of water were heated to SOC with agitation. 210 grams of HPLE partially defatted soybean flour as used in Example 2 were gradually added into the water and mixed for 5 minutes. Then, 0.1% of sodium sulfite (solids by weight) was added to the mixture and the pH was adjusted to 5.5 using a 50% citric acid solution. This acidic mixture was centrifuged at 4000 rpm for 10 minutes to separate the solids from the supernatant. The solids obtained in the centrifugation were a glycinin-rich precipitate having 21.67% dry solids with a 51.64% Kjeldahl dry basis protein and 8.68% dry basis acid hydrolyzed fat.

The pH of the supernatant was then adjusted to 4.5 by the addition of the 50% citric acid solution to precipitate a fraction rich in beta-conglycinin. The beta-conglycinin fraction was also separated and recovered by centrifugation as described above, and the precipitate had 39.74% dry solids with a 71.92% Kjeldahl dry basis protein and 13.94% dry basis acid hydrolyzed fat.

### EXAMPLE 7

### Comparison of the Protein:Water Gel Strength of Soy Protein Compositions.

Protein:water gel strength is a measure of the strength of a refrigerated gel of a soy protein. Protein:water gels are prepared by mixing a sample of soy protein material and ice water having a 1:5 protein:water ratio by weight based on a previous protein analysis using the Kjeldahl protein analysis as described in AOAC 18th Ed. Method 991.2.2 which is incorporated herein by reference in its entirety. The protein and ice water slurry is mixed in a Combimax 600 food processor (Braun, Boston, Mass.) for a period of time sufficient to permit the formation of a shiny and smooth gel. The gel was then placed in glass jars (Kerr Inc., Muncie, Ind.) so that no air remained. The jars were sealed with a metallic lid. The jars containing the soy gels were refrigerated for a period 30 minutes at a temperature of between −5° C. and 5° C. The gels were then cooked by placing the jars in a water bath at a temperature between 75° C. and 85° C. for 40 minutes. Finally, the gels were chilled to between −5° C. and 5° C. for a period of 12-15 hours. After the refrigeration period, the jars were opened and the gels separated from the jars leaving the gel as one piece. The strength of the gel was measured with a TX-TI texture analyzer (Stable Micro Systems, Godalming, UK) which drives a cylindrical probe (34 mm long by 13 mm diameter) into the gel until the gel is ruptured by the probe. The gel strength was calculated in newtons from the recorded break point of the gel.

Protein:water Gels were made from the dry second protein compositions from Examples 1 and 2. One commercial soy protein concentrate (Arcon S, ADM Decatur, Ill.) produced from hexane extracted soy flour by the acid wash process was compared to the soy protein composition produced in Example 3. The results are shown in Table 4.

TABLE 4
GEL STRENGTH

| | Gel Strength | Gel Strength |
|---|---|---|
| Product | (newtons) | (grams) |
| Isolate Process | | |
| Example 1 (EXP Isolate) | 1.91 | 195.2 |
| Example 2 (HPLE - Isolate) | 2.79 | 284.4 |
| Acid Wash Concentrate Process | | |
| Example 3 (HPLE - Concentrate) | 6.89 | 702.6 |
| Arcon S (ADM Concentrate) | 5.46 | 557.3 |

The gel strength of the soy protein produced from the HPLE soy flour is greater than the soy protein produced from the expeller press soy flour using the same method by approximately 45%. Additionally, the functional soy protein concentrate produced by the acid wash process from HPLE soy flour gel strength is 25% greater then the commercial acid wash soy protein concentrate produced from hexane extracted soy flour (Arcon S). The gel structures of all the products were firm, shiny and elastic.

### EXAMPLE 8

### Comparison of the Protein:Oil:Water Emulsion Strength of Soy Protein Compositions.

Protein:oil:water emulsion strength is a measure of the strength of a refrigerated oil and water emulsion with soy protein. Protein:oil:water emulsions are prepared by mixing a sample of soy protein material, soybean oil (Wesson Vegetable Oil), and ice water having a 1:5:6 protein:oil:water ratio by weight based on a previous protein analysis using the Kjeldahl protein analysis Method (AOAC 18th Ed. Method 991.2.2). The protein, oil and ice water slurry is mixed in a Combimax 600 food processor (Braun, Boston, Mass.) for a period of time sufficient to permit the formation of a smooth emulsion. The emulsion was then placed in glass jars (Kerr Inc., Muncie, Ind.) so that no air remained. The jars were sealed with a metallic lid. The jars containing the soy emulsions were refrigerated for a period 30 minutes at a temperature of between −5° C. and 5° C. The emulsions were then cooked by placing the jars in a water bath at a temperature between 75° C. and 85° C. for 40 minutes. Finally, the emulsions were chilled to between −5° C. and 5° C. for a period of 12-15 hours. After the refrigeration period, the jars were opened and the emulsions separated from the jars leaving the emulsions as one piece. The strength of the emulsion was measured with a TX-TI texture analyzer (Stable Micro Systems, Godalming, UK) which drives a cylindrical probe (34 mm long by 13 mm diameter) into the emulsion until it is ruptured by the probe. The emulsion strength was calculated in newtons from the recorded break point of the emulsion.

Protein:oil:water emulsions were made from the dry second protein compositions products of the soy isolate process from Examples 1 and 2. One commercial soy protein concentrate (Arcon S, ADM Decatur, Ill.) produced from hexane extracted soy flour by the acid wash process was compared to the soy protein composition of the acid wash process from Example 3. The results are shown in Table 5.

TABLE 5
EMULSION STRENGTH

| | Emulsion | Emulsion |
|---|---|---|
| | Strength | Strength |
| Product | (newtons) | (grams) |
| Isolate Process | | |
| Example 1 (EXP Isolate) | 0.85 | 86.5 |
| Example 2 (HPLE - Isolate) | 1.46 | 149.4 |
| Acid Wash Concentrate Process | | |
| Example 3 (HPLE - Concentrate) | 5.43 | 553.6 |
| Arcon S (ADM Concentrate) | 4.02 | 410.0 |

The emulsion strength of the soy protein produced using the HPLE soy flour is greater than the soy protein produced using the expeller press soy flour by approximately 72%. Additionally, the soy protein concentrate produced by the acid wash process from HPLE soy flour emulsion strength is 35% greater then the commercial soy protein concentrate produced from hexane extracted soy flour (Arcon S). Based on the emulsion data, it is clear that all of the products produced by using the HPLE flour have higher emulsion strength than the soy protein products prepared from hexane extracted and extruder pressed soy flours. Additionally, there was no fat separation from any of the HPLE emulsions.

### EXAMPLE 9 (PROPHETIC)

### Whole Muscle Meat Injection Using the Unique Soy Protein Compositions.

Meat brines (125% and 150%) may be prepared using each soy protein composition produced by Examples 2 through 6 in order to increase juiciness and yield of a lean ham or whole muscle meat product by injection. The brines are prepared by completely dispersing the protein in the ice water before adding other ingredients. The brines have the following compositions:

% In Brine

| | 125% | 150% |
|---|---|---|
| Ice Water % | 82.0 | 88.0 |
| Salt % | 9.0 | 4.5 |
| STTP % | 3.0 | 1.5 |
| Caregeenan % | 0.0 | 1.5 |
| Protein % | 6.0 | 4.5 |

The injection process is carried out using a Fomaco Injector model FGM 20/40 in two passes (25 psi injection pressure for the first pass and 20 psi for the second). The brine temperature is maintained at 4-6° C. The injected meat pieces are then tumbled in a DVTS-200 Vacuum Tumbler Machine (MPBS industries) for 12 hours with the remainder of the brine. The tumbled pieces are stuffed into 185 mm diameter casings and cooked for 2 hours and 30 minutes at 80° C. A 10° C. water shower is used for final cooling.

All of the resulting injected meat pieces will have a firm bite and dry surface with no visible strips or pockets of the injected brine. These meat pieces will have the following composition.

% In Final Meat

| | 125% | 150% |
|---|---|---|
| Water % | 13.7 | 29.4 |
| Salt % | 1.5 | 1.5 |
| STTP % | 0.5 | 0.5 |
| Caregeenan % | 0 | 0.5 |
| Meat | 83.3 | 66.6 |
| Protein % | 1 | 1.5 |

### EXAMPLE 10 (PROPHETIC)

### Meat Emulsion Preparation Using the Unique Soy Protein Compositions.

Meat emulsions may be formulated according to the following recipe and ingredients using the soy protein compositions of Examples 2, 3, 5 and 6.

| INGREDIENT | % IN FORMULA |
|---|---|
| Mechanically Deboned Meat (MDM) | 42.00 |
| PORK FAT | 9.00 |
| ICE/WATER | 32.28 |
| MODIFIED CORN STARCH | 3.00 |
| SOY PROTEIN | 5.50 |
| SEASONING | 5.00 |
| PHOSPHATE | 0.40 |
| CURE SALT | 0.32 |
| SODIUM LACTATE | 2.50 |
| TOTAL: | 100.00 |

The cure salt, phosphate, soy protein, MDM and half of the water are placed into a Hobart cutter and chopped until the protein is fully hydrated, followed by the addition of the remaining ingredients. The final emulsion is chopped until the emulsion reaches a temperature of 13° C., then sealed in a vacuum bag followed by hand stuffing a 70 mm impervious casing (liver sausage type) by cutting the vacuum bag end. The stuffed casings are held in ice water 30 minutes, and then cooked in an 80° C. water kettle until the internal temperature of the emulsion reaches 74° C. The cooked meat emulsion is then cooled in ice water.

Cooked meat emulsions prepared from the products of these Examples will exhibit a firm bite and dry surface with no visible fat separation.

### EXAMPLE 11 (PROPHETIC)

### Extended Meat Patties Prepared Using the Unique Soy Protein Compositions.

Meat patties extended with soy protein may be prepared by adding one part of the unique soy protein compositions produced in Examples 2, 3, 5 and 6 to be chopped with 2.5 parts of water at 70° C. in a food cutter (Hobart model 84145, Troy, Ohio) at slow speed for 20-30 seconds, followed by high speed cutting for 2 to 3 minutes, to produce wet gels. The wet gels are refrigerated overnight at 4-6° C. The gels are removed from refrigeration, and chopped for 10-20 seconds in the Hobart cutter to produce individual and distinct protein granules of approximately 30 mm size.

The granules produced as described above are then used to prepare hexane-free low fat burgers using the formula below. The ground beef is chopped in the Hobart cutter with the addition of water and granules for 2-3 minutes. The remaining ingredients are added to a mixer and blended for an additional 1 minute. The entire mixture is grounded in a meat grinder through a ⅛″ plate and formed into burgers using a former (Formax Inc. model F-6, Mokena, Ill.). The formed burgers are then frozen in a blast freezer at −40° C.

| Ingredients | % |
|---|---|
| Ground beef | 77.9 |
| Protein granules | 13 |
| Water | 5 |
| Caregeenan | 0.5 |
| Starch | 2.5 |
| Salt | 0.7 |
| Seasoning | 0.4 |

### EXAMPLE 12 (PROPHETIC)

### Meat Analog Patties are Prepared Using the Unique Soy Protein Compositions.

Protein granules are produced from soy proteins produced in Examples 2, 3, 5 and 6 as described in Example 11, and are used to prepare organic certified meat analog patties using the following formulation:

| Ingredients | % |
|---|---|
| Soy protein composition | 4.0 |
| Hexane free Protein granules | 15 |
| Wheat Gluten 75 (Fielders Starches, Port Melbourne, Australia) | 7 |
| Organic Soybean oil (Sunrich food group, Hope, MN) | 15 |
| Methyl cellulose, (Methocel A4M, Dow Chemical Company, | 1.5 |
| Midland, MI) | |
| Organic cane sugar | 0.3 |
| Organic TVP (Nutriant) | 18 |
| Organic Soy Okara (Sunrich food group, Hope, MN) | 3 |
| Water | 34.2 |
| Sodium carbonate | 0.4 |
| Salt | 1.2 |
| Seasoning (Ogawa Beef Flavor #B18538, 2.8 Ogawa, Tokyo, | 0.4 |
| Japan) | |

The organic TVP is mixed with 10% of the water and the sodium carbonate in a food cutter (Hobart Manufacturing Co., model 84145, Troy, Ohio) for two minutes. The protein granules are added to the mixture and mixed one minute and the mixture is then refrigerated at 4-6° C. The remaining water is heated to 80° C. and chopped on high speed with the methylcellulose for one minute in the same Hobart cutter. The soy protein composition is added to the cutter and chopped on high speed for 2 minutes. The soybean oil is added slowly with high speed chopping and chopped one minute. The remaining ingredients are added and chopped 3 minutes. The refrigerated TVP, granules, and sodium carbonate mixture is then added to the emulsion and mixed two minutes. The mixture is formed into patties using a Formax F-6 former (Formax Inc., Mokena, Ill.). Patties are flash frozen at −40° C.

### EXAMPLE 13 (PROPHETIC)

### Soy-Based Yogurt Analog Prepared Using the Unique Soy Protein Compositions.

Soy-based yogurt analogs may be prepared from the soy protein compositions identified in examples 2, 3, 5, and 6. The ingredients and formula are as follows.

| Ingredients | % |
|---|---|
| Sweet Dairy Whey | 34.5 |
| Soy Protein Product | 33.5 |
| Vegetable Oil | 26.2 |
| Sugar | 3.0 |
| Emulsifiers | 1.5 |
| Vitamins, Minerals | 1.0 |
| Flavoring | 0.5 |

All oils for the tests are combined in a tank and heated to 70° C., and the emulsifiers are added. The soy protein composition is dispersed in a separate tank with water at 49° C. at 18% solids. The whey and sugars are then added and blended for 15 minutes prior to the addition of the oil with emulsifiers. The solution is then heated to 90° C. for 5 minutes, homogenized in a two stage homogenizer at 2500 and 500 psi respectively, then cooled to 35° C. After the entire mixture reaches 35° C., a 2% standard yogurt starter culture is inoculated. The temperature is maintained at 35° C. until the pH of the mixture reaches 4.6, then the vitamins, minerals, and flavorings are added, and the mixture is cooled to 4° C. for packaging.

### EXAMPLE 14 (PROPHETIC)

### Ready to Drink and Powdered Beverages.

A high protein, ready to drink beverage may be formed using the unique soy protein composition of the present invention from examples 2, 4, 5, and 6. The ingredients used in the formulations are below.

### Ready to Drink:

| Ingredients | % |
|---|---|
| Water | 78.6 |
| Soy protein composition | 9.5 |
| Sucrose | 10.0 |
| Cocoa | 0.45 |
| Vitamins/Minerals | 0.5 |
| Flavor | 0.5 |
| Cellulose gel | 0.45 |

The soy protein composition is added to the water at 60° C. under strong agitation until fully hydrated. The cocoa is pre-blended with the cellulose gel and the sugar, then added to the protein water mixture and the final vitamins, minerals, and flavors are added. The mixture is homogenized, pasteurized, and packaged in aseptic or retort containers. One 240 ml serving of the high protein, ready to drink beverage will supply 20 grams of protein per serving.

### Powdered Beverage:

| Ingredients | % |
|---|---|
| Soy protein compositions | 59 |
| Sucrose | 13 |
| Maltodextrin | 27 |
| Vitamins/Minerals | 0.5 |
| Aspartame | 0.2 |
| Flavor | 0.3 |

All ingredients are added to a ribbon or other dry powder blender until all of the powdered ingredients are well mixed, then packaged. Thirty grams of the powdered beverage formulation may be added to 8 ounces of water or juice to form a serving containing about 15 grams of soy protein.

What is claimed is:

1. A plant protein composition comprising at least about 65% dry weight protein, prepared from a high pressure liquid extracted plant material having a PDI of at least about 65%.

2. The composition of claim 1, wherein the composition comprises about 15% or less dry weight fat.

3. The composition of claim 2, wherein the composition comprises about 10% or less dry weight fat.

4. The composition of claim 1, wherein the composition comprises at least about 80% dry weight protein.

5. The composition of claim 1, wherein the composition comprises at least about 90% dry weight protein.

6. The composition of claim 1, wherein the composition comprises a protein to fat ratio of greater than about 5:1.

7. The composition of claim 1, wherein the plant material has a PDI of at least about 70%.

8. The composition of claim 1, wherein the plant material is soy.

9. The composition of claim 8, the composition having a protein:water gel strength at least about 20% higher than that of a soy protein composition prepared from a hexane defatted soy material or hot pressed soy material.

10. The composition of claim 8, wherein the composition comprises at least about 80% dry weight protein and a protein:water gel strength greater than about 2.2 newtons as measured by the method of Example 7.

11. The composition of claim 8, the composition having an oil emulsion strength at least about 20% higher than that of a soy protein composition prepared from a hexane defatted soy material or a hot pressed soy material.

12. The composition of claim 8, wherein the composition comprises at least about 80% dry weight protein and an oil emulsion strength greater than about 1.1 newtons as measured by the method of Example 8.

13. A food product containing the plant protein composition of claim 1.

14. The food product of claim 13, wherein the food product is a confectionary product, a bakery product, an injection meat product, an emulsified meat product, a ground meat product, a meat analog product, a cereal, a bar, a dairy analog product, a beverage, a soymilk, a liquid or powdered dietetic formula, a texturized soy product, a pasta, a health nutrition supplement, or a nutrition bar.

15. The food product of claim 14, wherein the confectionary product is a candy or chocolate.

16. The food product of claim 14, wherein the bakery product is a bread, a roll, a biscuit, a cake, a yeast baked good, a cookie, a pastry, or a snack cake.

17. The food product of claim 14, wherein the injection meat product is a ham, a poultry product, a pork product, a seafood product or a beef product.

18. The food product of claim 14, wherein the emulsified meat product is a sausage, a bratwurst, a salami, a bologna, a lunchmeat, or a hot dog.

19. The food product of claim 14, wherein the ground meat product is a fish stick, a meat patty, a meatball, a ground pork product, a ground poultry product, a ground seafood product or a ground beef product.

20. The food product of claim 14, wherein the meat analog product is a meat patty, sausage, hot dog, lunchmeat, or ground crumble.

21. The food product of claim 14, wherein the dairy analog product is a milk product, a yogurt, a sour cream, a whipped topping, a ice cream, a cheese, a shake, a coffee whitener or a cream product.

22. The food product of claim 14, wherein the dietetic formula is an infant formula, a geriatric formula, a weight loss material, a weight gain material, a sports drink, or a diabetes management material.

23. A plant protein composition comprising a protein to fat ratio of at least 6:1, wherein the plant protein composition was prepared from a high pressure liquid extracted plant material having a PDI of at least 65%.

24. The composition of claim 23, wherein the protein to fat ratio is at least 8:1.

25. The composition of claim 23, wherein the plant is soy.

26. The composition of claim 23, wherein the plant material has a PDI of at least about 70%.

27. A food product containing the plant protein composition of claim 23.

28. The food product of claim 27, wherein the food product is a confectionary product, a bakery product, an injection meat product, an emulsified meat product, a ground meat product, a meat analog product, a cereal, a bar, a dairy analog product, a beverage, a soymilk, a liquid or powdered dietetic formula, a texturized soy product, a pasta, a health nutrition supplement, or a nutrition bar.

29. A plant protein composition comprising at least about 65% dry weight protein, prepared from a non-hexane, non-alcohol treated plant material having a PDI of at least about 65%.
